(19) United States
(12) Patent Application Publication
(10) Pub. No.: US 2026/0361907 A1
(43) Pub. Date: Nov. 12, 2026

(54) A CODING METHOD OR APPARATUS BASED ON CAMERA MOTION INFORMATION

(71) Applicant: InterDigital CE Patent Holdings, SAS, Paris (FR)

(72) Inventors: Sylvain THIEBAUD, NOYAL SUR VILAINE (FR); Tangi POIRIER, THORIGNE-FOUILLARD (FR); Pascal LE GUYADEC, ST GREGOIRE (FR); Saurabh PURI, SAINT-LAZARE (CA)

(21) Appl. No.: 19/491,712

(22) PCT Filed: Jun. 10, 2024
(86) PCT No.: PCT/EP2024/065953

§ 371 Date: Dec. 9, 2025

(30) Foreign Application Priority Data
Jun. 16, 2023 (EP) 23305961.7

(51) Int. Cl. H04N 19/51; H04N 19/105; H04N 19/176

(52) U.S. Cl. CPC H04N 19/51; H04N 19/105; H04N 19/176

(57) ABSTRACT

At least a method and an apparatus are presented for efficiently encoding or decoding video. For example, motion information is determined that is representative of camera motion between a current image and a reference image, where the current image and the reference image are part of a game engine 2D rendered video. For instance, motion information representative of camera motion is determined from depth value of the samples and camera parameters. Advantageously, two depth candidates per coding block allow deriving two depth parameters of a depth model for the coding block, the depth model including a plane representative of depth values of samples of the coding block. An encoding or a decoding method determines a motion compensated prediction of the coding block with respect to a reference image from the two of depth candidates.

### CROSS REFERENCE TO RELATED APPLICATIONS

This application claims the benefit of European Patent Application No. 23305961.7, filed on Jun. 16, 2023, which is incorporated herein by reference in its entirety.

### TECHNICAL FIELD

At least one of the present embodiments generally relates to a method or an apparatus for video encoding or decoding, and more particularly, to a method or an apparatus comprising determining two depth candidates of a depth model including a plane titled horizontally or vertically for a block coded with motion information representative of camera motion.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

To obtain coding gains, modern codec standards define more and more sophisticated tools, and let the codec encoder decide the best ones to use. In the scope of cloud gaming compression, minimizing the latency is key. Although intensive computation capabilities are required in recent encoders that introduce a latency between the rendering of the game content and its coding.

Existing methods for coding and decoding show some limitations in the domain of coding 2D rendered video of a game engine. Therefore, there is a need to improve the state of the art.

### SUMMARY

The drawbacks and disadvantages of the prior art are solved and addressed by the general aspects described herein.

According to a first aspect, there is provided a method. The method comprises video encoding by obtaining a coding block in a current image; determining two depth candidates for the coding block, wherein the two depth candidates allows deriving two depth parameters of a depth model, the depth model including a plane representative of depth values of samples of the coding block; determining a motion compensated prediction of the coding block with respect to a reference image from the two depth candidates, where motion information used in motion compensation is representative of camera motion between the current image and the reference image; and encoding the coding block based on the motion compensated prediction.

According to a second aspect, there is provided a method. The method comprises video decoding by obtaining a coding block in a current image; determining two depth candidates for the coding block, wherein the two depth candidates allows deriving two depth parameters of a depth model for the coding block, the depth model including a plane representative of depth values of samples of the coding block; determining a motion compensated prediction of the coding block with respect to a reference image from the two depth candidates, where motion information used in motion compensation is representative of camera motion between the current image and the reference image; and decoding the coding block based on the motion compensated prediction.

According to another aspect, there is provided an apparatus. The apparatus comprises one or more processors, wherein the one or more processors are configured to implement the method for video encoding according to any of its variants. According to another aspect, the apparatus for video encoding comprises means for implementing the method for video decoding according to any of its variants.

According to another aspect, there is provided another apparatus. The apparatus comprises one or more processors, wherein the one or more processors are configured to implement the method for video decoding according to any of its variants. According to another aspect, the apparatus for video decoding comprises means for implementing the method for video decoding according to any of its variants.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a block diagram of an example apparatus in which various aspects of the embodiments may be implemented.

FIG. 2 illustrates a block diagram of an embodiment of video encoder in which various aspects of the embodiments may be implemented.

FIG. 3 illustrates a block diagram of an embodiment of video decoder in which various aspects of the embodiments may be implemented.

FIG. 4 illustrates an example texture frame of a video game with a corresponding depth map.

FIG. 5 illustrates an example architecture of a cloud gaming system.

FIG. 6 illustrates a camera motion inter tool in a codec in which various aspects of the embodiments may be implemented.

FIG. 7 illustrates 4 exemplary representations of a plane of a depth model according to at least one embodiment.

FIG. 8 illustrates an example of complex motion vectors field due to the camera motion to which the at least one embodiment may apply.

FIG. 9 illustrates an example of an image with an horizontal constant plane to which the at least one embodiment may apply.

FIG. 10 illustrates an example of an image with horizontal constant plane to which the at least one embodiment has been applied.

FIG. 11 illustrates at least one embodiment related to Depth model 2V.

FIG. 12 illustrates an exemplary encoding method according to at least one embodiment.

FIG. 13 illustrates various depth parameters for a coding block according to at least one embodiment.

FIG. 14 illustrates a generic encoding method according to at least one embodiment.

FIG. 15 illustrates a generic decoding method according to at least one embodiment.

### DETAILED DESCRIPTION

Various embodiments relate to a video coding system in which, in at least one embodiment, it is proposed to adapt video coding tools to the cloud gaming system. Different embodiments are proposed hereafter, introducing some tools modifications to increase coding efficiency and improve the codec consistency when processing 2D rendered game engine video. Amongst others, an encoding method, a decoding method, an encoding apparatus, a decoding apparatus based on this principle are proposed. Although the present embodiments are presented in the context of the cloud gaming system, they may apply to any system where a 2D video may be associated to with camera parameters, such as a video captured by mobile device along with sensor's information allowing to determine the position and characteristics of the device's camera capturing the video. Depth information may be made available either from a sensor or other processing.

Moreover, the present aspects, although describing principles related to particular drafts of VVC (Versatile Video Coding) or to HEVC (High Efficiency Video Coding) specifications, or to ECM (Enhanced Compression Model) reference software are not limited to VVC or HEVC or ECM, and can be applied, for example, to other standards and recommendations, whether pre-existing or future-developed, and extensions of any such standards and recommendations (including VVC and HEVC and ECM). Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

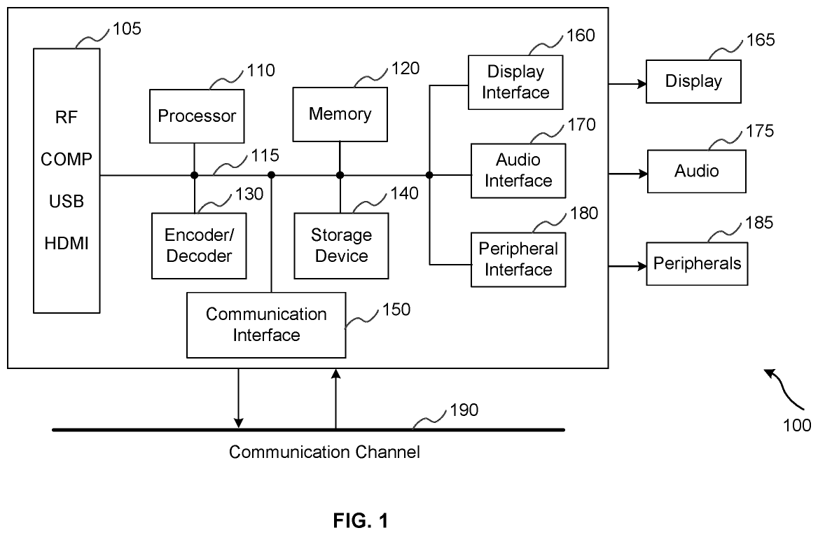

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g. a volatile memory device, and/or a non-volatile memory device).

System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

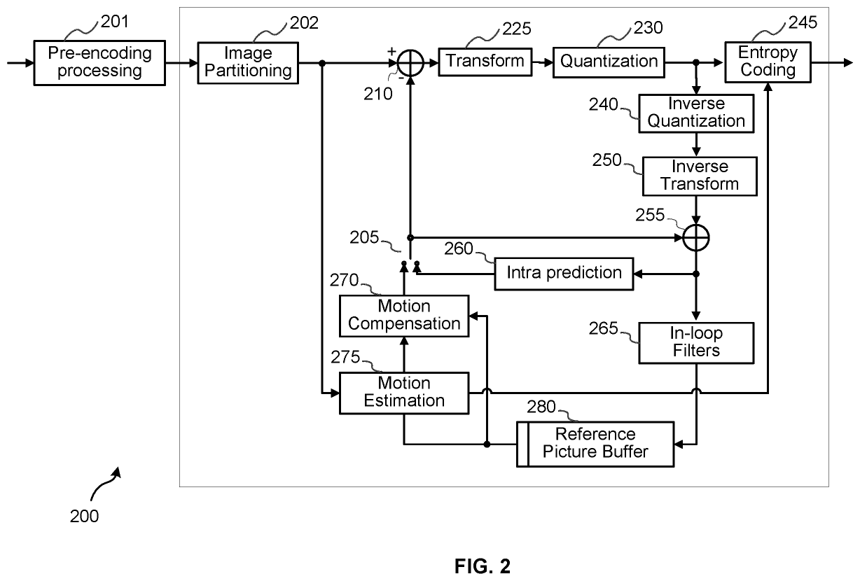

FIG. 2 illustrates an example video encoder 200, such as VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

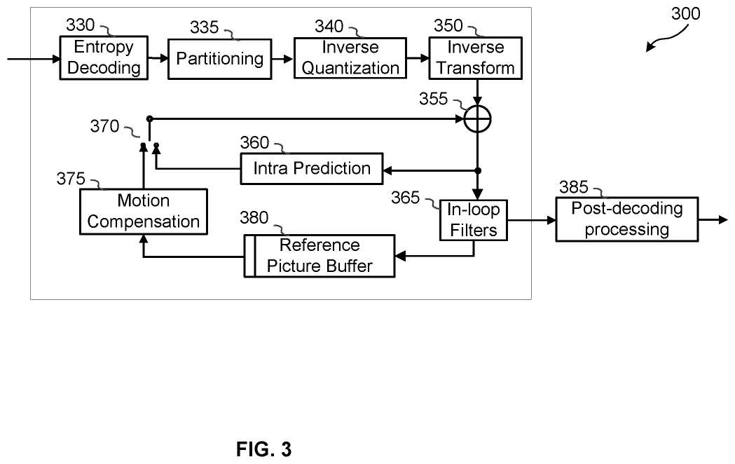

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

A video coding system such as a cloud gaming server or a device with light detection and ranging (LiDAR) capabilities may receive input video frames (e.g., texture frames) together with depth information (e.g., a depth map) and/or motion information, which may be correlated.

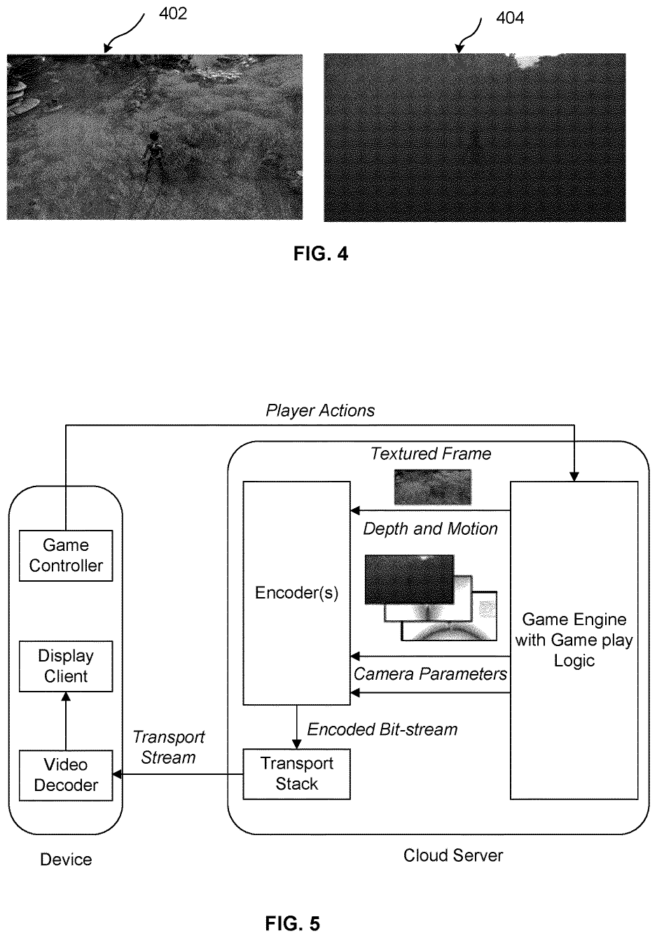

FIG. 4 illustrates an example texture frame 402 of a video game with a corresponding depth map 404 that may be extracted (e.g., directly) from a game engine that is rendering the game scene. A depth map may be provided by the game engine in a floating-point representation. A depth map may be represented by a grey-level image, which may indicate the distance between a camera and an actual object. A depth map may represent the basic geometry of the captured video scene. A depth map may correspond to a texture picture of a video content and may include a dense monochrome picture of the same resolution as the luma picture. In examples, the depth map and the luma picture may be of different resolutions.

FIG. 5 shows an example architecture of a cloud gaming system, where a game engine may be running on a cloud server. The gaming system may render a game scene based on the player actions. The rendered game scene may be represented as a 2D video including a set of texture frames. The rendered game engine 2D video may be encoded into a bitstream, for example, using a video encoder. The bitstream may be encapsulated by a transport protocol and may be sent as a transport stream to the player's device. The player's device may de-encapsulate and decode the transport stream and present the decoded 2D video representing the game scene to the player.

According to various implementations, additional information such as a depth information, motion information, an object ID, an occlusion mask, camera parameters, etc. may be obtained from a game engine (e.g., as outputs of the game engine) and made available to the cloud server (e.g., an encoder of the cloud) as prior information.

According to at least one embodiment, a video to encode is generated by 3D game engine as shown in the cloud gaming system of FIG. 5 where the video only includes texture information and synchronized camera parameters. As additional information (e.g. depth map) obtained from the game engine may represent a large amount of data, it is desirable to skip some of the available additional information. Additional information described herein such as the motion information issued from state of the art motion estimation in the encoder, or camera parameters or a combination thereof may be utilized to perform motion compensation in the rendered game engine 2D video in a video processing device (e.g., the encoder side of a video codec) as for instance described in the EP application 22306847.9 filed on 12 Dec. 2022 by the same applicant which is incorporated herein by reference. Advantageously, the motion compensation generates inter prediction based on new motion information that is responsive to a new motion model in order to improve coding gains (e.g., compression gains). This new motion model, described in the EP application 22306847.9, may render the motion of a camera in the 3D game engine. The processing based on the camera parameters is referred to as Camera Motion tool or Camera Motion Inter tool in the present disclosure. The Camera Motion tool allows predicting motion in areas of a current image where motion is only affected by the virtual camera of the game engine (its characteristics and position). The present principles address the deriving of depth information to be used Camera Motion Inter tool in both the encoder and the decoder by the propagation of depth parameter of neighboring blocks.

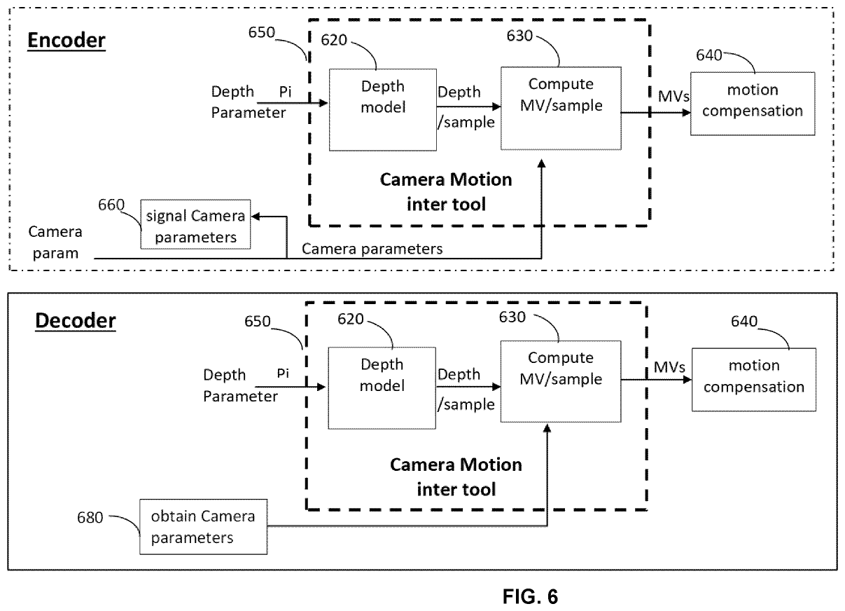

FIG. 6 illustrates a camera motion inter tool in a codec in which various aspects of the embodiments may be implemented. According to a salient feature, camera motion inter tool 650 approximates the depth of the CU to be compressed to a plane. Depending on the orientation of this plane in the 3D space, four different depth models can be used to approximate the plane, characterized by 1, 2 or 3 depth parameters Pi. These depth parameters do not represent the depth in the 3D scene, but a third coordinate representing the depth associated to the 2D image coordinates. Usually, this third coordinate may be obtained from the projection of a 3D point by the game engine's virtual camera. According to a salient feature described in the EP application 22306847.9, this third coordinate may be obtained from the projection of a reconstructed 3D point, the 3D point being reconstructed from motion information, such as a motion vector and reference picture, associated with the 2D image sample. Thanks to the depth models, characterized by only few depth parameters i.e. a few motion vectors such as the motion vector of an already reconstructed sample, a depth information is available per pixel (or per 4×4 pixel blocs in VTM) in a camera motion coded block. This depth information, associated with the camera parameters, is used to compute a motion vector per sample. Then the motion compensation 640 can be performed, as it is performed in the state of art.

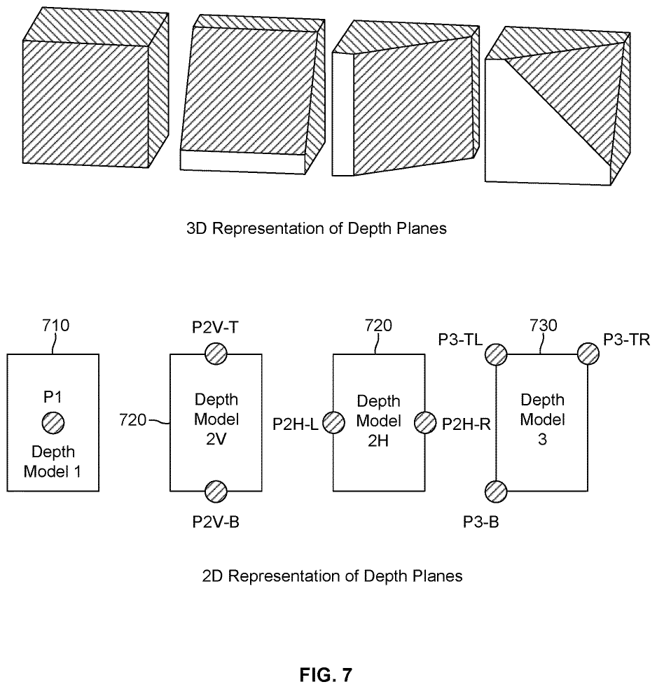

FIG. 7 illustrates 4 exemplary representations of a plane of a depth model as disclosed in the EP application 22306847.9. The hatched planes represent some planes in the 3D game scene which are only affected by the game engine's camera. Below these 3D hatched planes, an exemplary Camera Motion Coding Block (CB) 710, 720, 730 corresponding to the projection of a part of the hatched planes by the camera is represented.

According to a first variant, a depth model for the coding block includes a plane parallel to a camera's sensor and is characterized by one depth parameter. In this variant, the plane 710 of the coding block may be approximated by a plane parallel to the camera's sensor, the coding block is represented by only one depth parameter (Depth Model 1). The depth parameter represents the depth value of the central sample P1 in the coding block, which is also the depth value of any sample in the coding block.

According to a second variant, a depth model for the coding block includes a plane 720 tilted vertically or horizontally with respect to a camera's sensor and the depth model is characterized by two depth parameters. In this variant, the plane may either be tilted horizontally (Depth Model 2H implying a horizontal depth interpolation) or vertically (Depth Model 2V implying a vertical depth interpolation). In this case, two depth parameters are required to define the depth plane. For instance, for the Depth Model 2V, a first depth parameter represents a depth value of a central sample P2V-T on a top border line of the coding block and a second depth parameter represents a depth value of a central sample P2V-B on a bottom border line of the coding block. For instance, for the Depth Model 2H, a first depth parameter represents a depth value of a central sample P2H-L on a left border line of the coding block and a second depth parameter represents a depth value of a central sample P2H-R on a right border line of the coding block. Then, the depth of any sample in the coding block is determined using an interpolation between the depth values indicated by the two depth parameters.

According to a third variant, a depth model for the coding block includes a plane tilted vertically and horizontally with respect to a camera's sensor and the depth model is characterized by three depth parameters. In the variant, the plane is tilted in both directions (Depth Model 3) and three parameters are required. For instance, for the Depth Model 3, the three parameters respectively represent the depth value of a top-left sample P3-TL of the coding block, a depth value of a top-right sample P3-TR of the coding block, a depth value of a bottom-left sample P3-B of the coding block. The skilled in the art will appreciate that the positions of samples used in the depth plane model are non-limiting examples, and that the present principles may contemplate any implementation of depth parameters allowing to define the 4 plane models.

Back to FIG. 6, the new Camera Motion Inter tool consists in computing the motion vectors in a new way for contents such as game engine contents. The Camera Motion inter tool 650 is indicated by the dotted line in encoder and decoder scheme of FIG. 6. Firstly, for each sample of the block (or a sub-sampled set in the block, sub-sampling by 4 in both direction for instance), an estimate of the depth of a sample is computed 620 depending on its position, the Camera Motion Depth Model and its associated parameters, where the depth in the coding block is represented with a parametric plane. Secondly, a motion vector is computed 630 depending on the sample position, the estimate depth and the camera parameters. The block diagram of FIG. 6 partially represents modules of an encoder or encoding method, for instance implemented in the exemplary encoder of FIG. 2. The block diagram of FIG. 6 further partially represents modules of a decoder or decoding method, for instance implemented in the exemplary decoder of FIG. 3. The Camera Motion inter tool receives some depth model parameters Pi along with camera parameters and provides motion vectors MVs used to compute the motion compensation 640. The camera parameters represent the characteristics and the position of the game engine's virtual camera. They are provided for the reference image and for the current image to be encoded. In an embodiment, the encoder may obtain a depth parameter Pi for a depth model i that approximates the depth at the coding block position with a plane. Depending on the depth model, the coding block depth is approximated with a plane characterized by up to 3 parameters Pi. For instance, for the Depth Model 1 representing a block with constant depth, a single depth parameter P1 may be obtained by taking one of the depth of the central pixel of the coding block, an average depth around the central pixel of the coding block, or the average depth of the coding block, with or without sub-sampling. Advantageously, the parameter of depth model for the coding block is determined from a list of depth candidates from a causal neighborhood. According to a first variant, the depth parameter of a depth candidate is derived from a depth information associated to a neighboring block previously reconstructed. According to a second variant which is out of the scope of the present application, the depth parameter of a depth candidate is derived from a motion vector information associated to a neighboring block previously reconstructed. An example of the deriving of an estimate depth value used as depth parameter is described in the EP application 23305419.6 filed on 28 Mar. 2023 by the same applicant which is incorporated herein by reference. Then, the encoder reconstructs 620 depth values of the coding block based on the depth model parameters Pi. It determines an estimation of the depth value of any sample of the coding blocks. A motion vector responsive to camera motion compensation per sample is computed depending on its position, its approximated depth, and the camera parameters. Depending on the implementation, to reduce the complexity, a motion vector may be computed for a block of samples. For instance, a motion vector is computed per block of 4×4 samples. These motion vectors are then used to perform the motion compensation 640 as known by the skilled in the art. Since this vector is computed with the depth and the camera parameters, it represents the displacement of the current sample between the reference frame and the current frame due to a camera motion (translations and/or rotations), or a modification of the camera's characteristics (focal length, . . . ). Different depth candidates processed by the Camera motion inter tool may be put into competition into a RDO loop to determine the motion model along with an associated depth candidate that result in the lower rate distortion cost. Additionally, the encoder may further provide adequate signaling of the selected depth model and depth candidate to enable a decoder to recover the one or more parameters Pi to be used at the input of the camera motion inter tool 650. According to at least one embodiment, the depth parameters Pi may be derived using motion information or depth information associated to a depth candidate in a list. Additionally, the encoder may further signal 660 camera parameters for the images.

On the decoder side, the Camera motion inter tool computes Camera Motion MVs as done in the encoder. To that end, the decoder obtains, two depth candidates in a causal neighborhood used to derive the one or more parameters Pi of the depth model of a coding block to decode where the depth model includes a plane either titled horizontally or vertically. Additionally, the decoder obtains 680 camera parameters for the current image and for the reference image. The camera parameters for the reference image may be stored locally in the decoder at the reconstruction of the reference image. The depth parameter of the particular depth candidate may be stored locally in the decoder for processing of the next coding blocks to decode.

In the following, at least one embodiment to obtain the depth information Pi of the depth model for the camera motion inter tool are detailed. The input parameters Pi characterizing the depth model of the Camera Motion inter tool represent a depth information. In the EP application 22306847.9, this depth information could be available at the encoder side, for instance when they are provided by a game engine as a depth map associated to the texture. But in this case, the amount of information to be transmitted to the decoder is not acceptable in the scope of video compression. In the EP application 23305419.6, this depth information may be obtained from motion information of the 2D video. It is desirable to provide such parameters representing the depth to the Camera Motion tool while limiting extra cost due to the transmission of depth information to the decoder and limiting the processing complexity. According to at least one embodiment, two depth candidates are determined for the coding block, wherein the two depth candidates allows deriving two depth parameters of a depth model for the coding block, the depth model including a plane representative of depth values of samples of the coding block either tilted horizontally or vertically, and a motion compensated prediction of the coding block with respect to a reference image is determined from the two depth candidates.

As presented with FIG. 7, the Camera Motion Depth Model 2V and 2H only requires two depth parameters to approximate the CU to a plane. Then, this model can be used to compute a motion vector per pixel or bloc of pixels, before performing the motion compensation.

In the context of video compression codecs, to compress the current CU, the encoder selects the tool providing the lower Rate-Distortion cost, considering the number of bits required to code the information and the distortion of the decompressed CU. This selection is performed by the Rate-Distortion optimization, consisting in evaluating, for different partitioning, the RD-Cost of each tool with its different configurations. For example, VVC introduces a new motion model, the affine motion model based on motion field that better captures the motion due to rotation and zooming. The Affine tool may usually be used to code CUs efficiently predicted by complex motions fields for instance due to camera rotations. Besides, if the depth of the CU is constant, for instance being represented with the Depth Model 1 of FIG. 7, a motion of translation of the camera provides the same motion vector for each pixel of the CU. However, if the depth of CU is tilted vertically or horizontally, for instance being represented with the Depth Model 2V and 2H, a simple camera translation provides different motion vectors as the apparent motion depends on the distance to the camera. This CU may typically be coded by the Affine tool. Unfortunately, even if the Affine tool may be the best tool to represent such complex motion fields, the cost for signaling an affine motion model may be pretty high. At least one embodiment addresses the issue of how to implement the Camera Motion tool using the Depth Model 2V or Depth Model 2H in a video codec where no depth information is available. When the CU depth plane is tilted vertically (the depth depends on the vertical pixel position) or horizontally (the depth depends on the horizontal pixel position), it can be characterized by two depth parameters derived from the motion vectors of the adjacent CUs, particularly when these CUs are Affine (not exclusively). Then, the camera motion model advantageously replaces Affine motion model to provide compression gains.

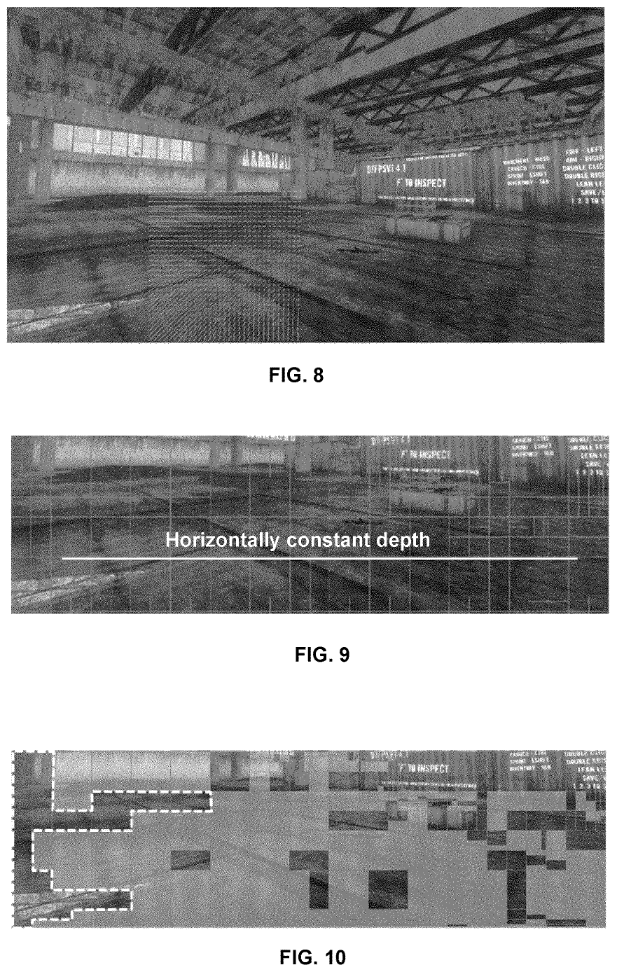

FIG. 8 illustrates an example of complex motion vectors field due to the camera motion to which the at least one embodiment may apply. As players usually move in the 3D scene, the foreground content at the bottom is very often representing the floor. Its depth varies very rapidly, causing a fast variation in the motion vector values in the same CU. The floor at the foreground provides a good example of how our tool works. On this example coded with VVC, this floor is mostly coded by Affine AMVP and Affine Merge to model the complex motions field.

On this example of content, the floor may be approximated to a plane in the 3D scene. In the image, the depth of this plane depends on the vertical pixel position. As presented in the EP application 22306847.9, it can be modelized by the Camera Motion Depth Model 2V, characterized by the two depth parameters P2V-T and P2V-B. The depth is constant or almost constant horizontally as shown in FIG. 9.

At least one embodiment relates to providing the depth parameters P2V-T, P2V-B, P2H-Land P2H-R. According to least one embodiment, the already coded CUs located at the left of the current CU provide the depth parameters for the Depth Model 2V (parameters P2V-T and P2V-B). The CUs located on the top of the current CU provide the depth parameters for the Depth Model 2H (parameters P2H-L and P2H-R). If the CU providing the depth parameters has been coded by a legacy inter tool, these parameters are approximated with the motion vectors of the CU. If this CU has been coded by Camera Motion, the depth is already available in the codec and can be used as depth parameter. Since the depth parameters P2V-T and P2V-B are provided by the depth of the CUs located at the left of the current CU, the Camera Motion Depth Model 2V is used to propagate the depth horizontally. This depth model will for instance be used to code the floor and the roof of the gaming content of FIG. 9. The depth parameters P2H-L and P2H-R being provided by the depth of the CUs located on the top of the current CU, the Camera Motion Depth Model 2H is used to propagate the depth vertically. Some walls or buildings in the game scene may be coded with this model.

FIG. 10 illustrates an example of an image with horizontal constant plane to which the at least one embodiment has been applied. In the example of FIG. 10, the Camera Motion Depth Model 2V is used on the part of the gaming content representing the floor in foreground. The CUs in grey have been coded by the Camera motion tool while various motion tools (such as Affine) were in competition. Almost all other CUs have been coded with Affine, especially the CUs surrounded by the dotted white line, located at the left. Since no depth information is provided to the codec, no depth information is available to code these first surrounded CUs with Camera Motion. These CUs are coded with Affine, and more specifically with Affine AMVP, which is costly in term of data. When the motion vectors provided by Affine AMVP represent the real motion vectors, they can be used to approximate the depth efficiently. Then, the modeling of the depth information using Camera Motion Depth Model 2V may be used with these depth parameters. According to a specific feature, the current depth information is stored in the codec to provide depth information for the next CUs. According to yet another feature of the at least one embodiment, the depth is propagated horizontally, with an intensive usage of the Camera Motion model, representing more than 50% of the image surface in this example (where all the motion is due to the camera).

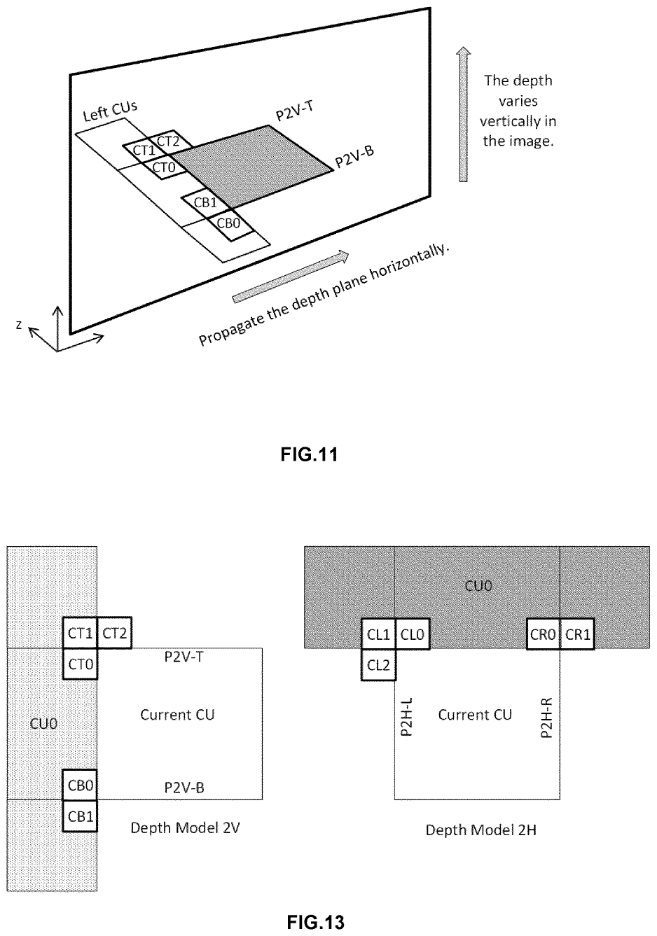

FIG. 11 illustrates at least one embodiment applied to a Depth model 2D. The current CU (hatched) represents a part of the floor. In the image, the depth is constant horizontally and varies vertically. The depth parameters P2V-T and P2V-B for the current CUs are provided by the depth of the CUs located at the left (CT0, CT1, CT2 provide P2V-T and CB0, CB1 provide P2V-B). The example of FIG. 11 shows how the Camera Motion Depth Model 2V may propagate the depth horizontally. The propagated depth may be issued from a depth information if the previous CU at the left has been coded by Camera Motion or may be issued from a motion vector if this CU has been coded with legacy inter tools. The skilled in the art would non-ambiguously apply the same mechanism to the Camera Motion Depth Model 2H when the depth depends on the horizontal pixel position and propagating the depth vertically instead of horizontally. Therefore, only one depth parameter has to be estimate for the Camera Motion tool. As described hereafter, the present principles advantageously require almost no extra signaling for estimating a 2H or 2V depth model for camera motion model. The encoder only has to signal that the camera motion tool is used to code the CU. For instance, in that case, no candidate index is needed. It means that the signaling cost of such implementation of the camera motion tool is very low, and only depends on its position in the CU syntax tree. Depending on this position it may be in competition with other inter tools than Affine using a motion vector per CU.

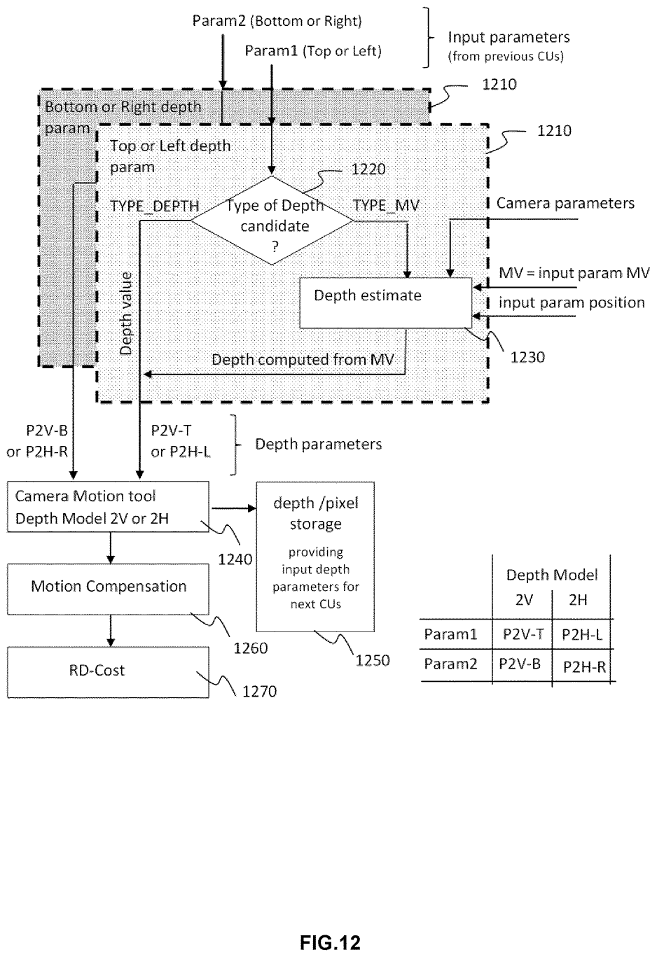

FIG. 12 illustrates an exemplary encoding method according to at least one embodiment. In the exemplary embodiment of FIG. 12, the encoder uses the Camera Motion Depth Model 2V or 2H. These two depth models represent the depth of the CU as a plane tilted vertically or horizontally, characterized by two depth parameters as shown on FIG. 7. In a step 1210, these two depth parameters Param1 and Param2 characterizing the depth plane are input. The input parameter Param1 provides the depth parameter P2V-T for the Depth Model 2V or the parameter P2H-L for the Depth Model 2H. The parameter Param2 provides the depth parameter P2V-B for the Depth Model 2V or the parameter P2H-R for the Depth Model 2H.

The input parameters Param1 and Param2 are obtained from causal neighborhood and, as such, they are referred to as spatial depth candidates or depth candidates. The way Param1 and Param2 are obtained will be detailed with FIG. 13.

According to a particular feature, the depth candidate may have a type characterizing the type of information it comprises. Accordingly, a depth candidate may comprise motion vectors and/or depth information. When the candidate comes from a CU coded by a legacy inter tool, a depth candidate may comprise a motion vector information. Such depth candidate may be referred to as a depth candidate of type motion vector (TYPE_MV). In this case, this motion vector information is used to estimate a depth value in 1230 providing a depth parameter of the depth candidate, at the encoder and the decoder side. The deriving of this depth estimate is, for instance, described in the EP application 23305419.6. According to a particular feature, a depth candidate of type motion vector may further comprise an information associated with the spatial position of the pixel associated with the motion information as this information is needed to estimate 1230 the depth value. When the candidate comes from a CU that has previously been compressed by a Camera Motion tool, a depth candidate may comprise a depth information. Such depth candidate may be referred to as a depth candidate of type depth (TYPE_DEPTH). With these two depth parameters, the Camera Motion tool 1240 computes a depth per pixel or block of pixels, used to perform the motion compensation 1270. Then the encoder can compute the RD-Cost estimation 1270.

Besides, when the Camera Motion tool is selected by the encoder as the best tool to encode the current CU, a depth information per pixel or block of pixels is stored 1250 in the codec. This depth information is the depth of the pixel or block of pixels computed by the Depth Model. This depth information will be used as a potential input parameter of type TYPE_DEPTH for the next CUs to be coded. On the contrary, if the CU located before the current CU (CU at the left for the Depth Model 2V or at the top for the Depth Model 2H) was coded with a legacy inter tool, it provides a depth candidate of type motion vector TYPE_MV as input parameter. The step 1230 converts this TYPE_MV input parameter to a depth value TYPE_DEPTH. If Camera Motion mode is selected as the best tool to code the current CU, these estimated depth values are stored in the codec. These depth values may provide depth candidates (i.e. from input parameter) of type TYPE DEPTH to the next CUs.

The skilled in the art will appreciate that once a legacy inter tool has provided motion vectors representing the real motion, these motion vectors are converted to depth, and are advantageously propagated, horizontally for the Depth Model 2V or vertically for the Depth Model 2H. In the example of FIG. 10 the first motion vectors at the left (CUs surrounded by the dotted white line) are provided by Affine. They are used to approximate the depth parameters used by Camera Motion, which is selected by the encoder as the best inter tool. These depth parameters are propagated horizontally, allowing an intensive usage of the camera motion model, thus providing compression gains.

According to another variant, the input parameters of type depth may also be provided by a different depth model. For instance, the depth information per pixel or block of pixels may be provided as described in the application referenced under “2023P00243EP—Camera Motion inter tool with constant CU depth” filed on the same day by the same applicant.

If FIG. 12 presents the block diagram of an embodiment as implemented at the encoder side, the skilled in the art will non-ambiguously recognize that the block diagram for the decoder is the same, but without the RD-Cost operation which is obviously specific to the encoder. The signaling associated to the camera motion model is minimal: the encoder has only to signal that the model is used to code the CU (neither parameter, nor index are to be signaled). The motion vectors per pixel or block of pixels may be computed with the camera parameters to perform a very accurate motion compensation. This low signaling cost associated to a good motion compensation explain the coding efficiency of such camera motion model.

FIG. 13 illustrates various depth parameters for a coding block according to at least one embodiment. More specifically FIG. 13 illustrates the way the input parameters are built for the Depth Model 2V and the Depth Model 2H. As previously shown with FIG. 12, the Camera Motion depth model 1240 requires two depth parameters representing the depth plane using a depth model 2V or 2H. The two input parameters Param1 and Param2 are processed in 1210 to provide these depth values. As presented with FIG. 13, these input parameters or depth candidate may be provided by the previous adjacent CUs. A depth plane for the Depth Model 2V is characterized by its top P2V-T and bottom P2V-B depth parameters. Since the Camera Motion may propagate the depth horizontally, these parameters are provided by the adjacent CUs on the left (since obviously the adjacent CUs should be available when coding the current CU, that is not the case for the CUs on the right). The most reliable parameter representing the P2V-T top parameter for the current CU is CT0, located on the top line of the current CU and the right column of the adjacent CU0. In the same way, the most reliable parameter to represent the P2V-B bottom parameter of the current CU is CB0, located on the bottom line of the current CU and the right column of the adjacent CU0. The Depth Model 2V cannot be used if no motion vector (CU0 not coded by an inter tool) and no depth information (CU0 not coded by Camera Motion) are available in CT0 or CB0. For this reason, if CT0 is not available, it can be replaced by CT1, located just above, or by CT2 located at the right of CT1. if CB0 is not available, it can be replaced by CB1, located just below. The depth plane for the Depth Model 2H is characterized by its left P2H-L and right P2H-R depth parameters. Since for this model of Camera Motion propagates the depth vertically, these parameters are provided by the adjacent CUs on the top (since obviously the adjacent CUs should be available when coding the current CU, that is not the case for the CUs on the bottom).

The most reliable parameter representing the P2H-L left parameter for the current CU is CL0, located on the left column of the current CU and the bottom line of the adjacent CU0. In the same way, the most reliable parameter to represent the P2H-R right parameter of the current CU is CR0, located on the right column of the current CU and the bottom line of the adjacent CU0. The Depth Model 2H cannot be used if no motion vector (CU0 not coded by an inter tool) and no depth information (CU0 not coded by Camera Motion) are available in CL0 or CR0. For this reason, if CL0 is not available, it can be replaced by CL1, located just at its left, or by CL2 located just below CL1. If CR0 is not available, it can be replaced by CR1, located just at its right.

The input parameters or depth candidate may be of type TYPE_MV when the CU providing the parameter has been coded by a legacy inter tool, or of type TYPE_DEPTH when this CU has been coded by Camera Motion. When the input parameter is TYPE_MV, its image position is required to estimate a depth value from the motion vector. When the adjacent CUs do not provide depth parameters, the encoder may search further than the adjacent CUs to find them. For instance, to find depth parameters for the Depth Model 2V, the encoder may scan the CUs horizontally, in the left direction. For the Depth Model 2V, when no depth parameters are provided by the top adjacent CUs, the encoder may scan the CUs vertically, in the top direction.

According to yet another variant, instead of electing the two depth candidates according to an ordered list of a first neighboring CU (such as CT0, CT1, CT2) with a second neighboring CU (such as CB0, CB1), a list of all available combinations of two depth candidate may be determined among (CT0, CB0), (CT1, CB0), (CT2,CB0), (CT0, CB1), (CT1, CB1), (CT2,CB1). At the encoding, a RD-optimization allows to select a particular set of two depth candidates among the different available pair of candidates in the list of all available combinations. Then, the set of two depth candidates is provided to the decoder by signaling/encoding an index in the ordered list. At the decoding, the selected pair of depth candidates in the list is retrieved from the signaled index.

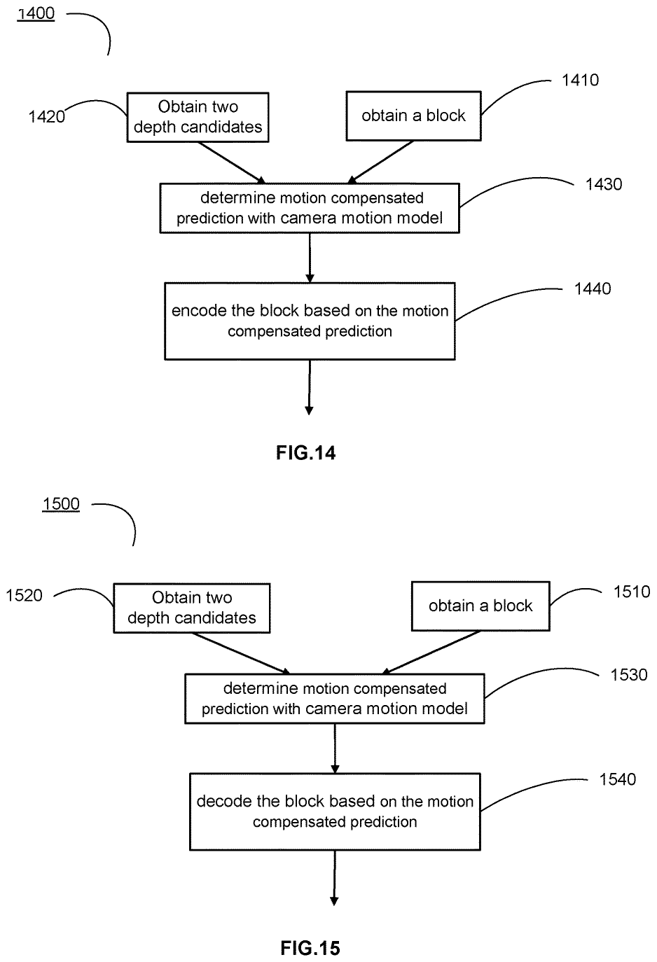

FIG. 14 illustrates a generic encoding method 1400 according to at least one embodiment. In a first step 1410, a coding block in a current image is obtained. In a step 1420, two depth candidates are determined for the coding block, where the two depth candidates allows deriving two depth parameters of a depth model for the coding block. The depth model includes a plane representative of depth values of samples of the coding block. For instance, the plane is tilted vertically with respect to the camera's sensor and the two depth parameters are respectively representative of a depth value of a sample on a top border line of the coding block and on a bottom border line of the coding block. Then, the two depth candidates for the coding block are a top-left adjacent block and a bottom-left adjacent block. For instance, the plane is tilted horizontally and the depth parameters are respectively representative of a depth value of a sample on a left border column of the coding block and on a right border column of the coding block. Then, the two depth candidates for the coding block are a top-left adjacent block and a top-right adjacent block. The encoding method determines for instance responsively to a RD-cost a depth model to be used for the encoding. In a step 1430, a motion compensated prediction of the coding block with respect to a reference image is computed from the two depth candidates. Here, the motion information used in motion compensation is representative of camera motion between the current image and the reference image. Finally in a step, 1440, the coding block is encoded based on the motion compensated prediction.

FIG. 15 illustrates a generic decoding method 1500 according to at least one embodiment. In a first step 1510, a coding block to decode in a current image is obtained. In a step 1520, two depth candidates are determined for the coding block, where the two depth candidates allows deriving two depth parameters of a depth model for the coding block. The depth model includes a plane representative of depth values of samples of the coding block. For instance, the plane is tilted vertically with respect to the camera's sensor and the two depth parameters are respectively representative of a depth value of a sample on a top border line of the coding block and on a bottom border line of the coding block. Then, the two depth candidates for the coding block are a top-left adjacent block and a bottom-left adjacent block. For instance, the plane is tilted horizontally and the depth parameters are respectively representative of a depth value of a sample on a left border column of the coding block and on a right border column of the coding block. Then, the two depth candidates for the coding block are a top-left adjacent block and a top-right adjacent block. In a step 1530, a motion compensated prediction of the coding block with respect to a reference image is computed from the two depth candidates. Here, the motion information used in motion compensation is representative of camera motion between the current image and the reference image. Finally in a step, 1540, the coding block is decoded based on the motion compensated prediction.

### ADDITIONAL EMBODIMENTS AND INFORMATION

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the inter prediction modules (270, 275, 375), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented as various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation;
RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
obtaining a coding block in a current image;
determining two depth candidates for the coding block, wherein a first depth candidate is obtained from a first adjacent block to the coding block and a second depth candidate is obtained from a second adjacent block to the coding block, wherein a depth model for the coding block includes a plane tilted vertically or horizontally with respect to a camera's sensor and is characterized by two depth parameters;
deriving two depth parameters of the depth model for the coding block from the first depth candidate and from the second depth candidate;
determining a motion compensated prediction of the coding block with respect to a reference image from the depth model for the coding block, where motion information used in motion compensation is representative of camera motion between the current image and the reference image; and
encoding the coding block based on the motion compensated prediction.

2. The method of claim 1, wherein a depth candidate among the two depth candidates comprises a depth information associated to an adjacent block.

3. The method of claim 1, wherein a depth candidate among the two depth candidates comprises a motion vector information associated to an adjacent block.

4. The method of claim 3, wherein the depth candidate further comprises a coordinate information of a sample of an adjacent block associated to the vector information.

5. (canceled)

6. The method of claim 15, wherein the plane is tilted vertically and the two depth parameters are respectively representative of a depth value of a sample on a top border line of the coding block and on a bottom border line of the coding block.

7. The method of claim 6, wherein the two depth candidates for the coding block are a top-left adjacent block and a bottom-left adjacent block.

8. The method of claim 1, wherein the plane is tilted horizontally and the depth parameters are respectively representative of a depth value of a sample on a left border column of the coding block and on a right border column of the coding block.

9. The method of claim 8, wherein the two depth candidates for the coding block are a top-left adjacent block and a top-right adjacent block.

10-12. (canceled)

13. A method, comprising:
obtaining a coding block in a current image;
determining two depth candidates for the coding block, wherein a first depth candidate is obtained from a first adjacent block to the coding block and a second depth candidate is obtained from a second adjacent block to the coding block, wherein a depth model for the coding block includes a plane tilted vertically or horizontally with respect to a camera's sensor and is characterized by two depth parameters;
deriving two depth parameters of the depth model for the coding block from the first depth candidate and from the second depth candidate;
determining a motion compensated prediction of the coding block with respect to a reference image from the depth model for the coding block, where motion information used in motion compensation is representative of camera motion between the current image and the reference image; and
decoding the coding block based on the motion compensated prediction.

14. The method of claim 13, wherein a depth candidate among the two depth candidates comprises a depth information associated to an adjacent block.

15. The method of claim 13, wherein a depth candidate among the two depth candidates comprises a motion vector information associated to a adjacent block.

16. The method of claim 15, wherein the depth candidate further comprises a coordinate information of a sample of an adjacent block associated to the vector information.

17. (canceled)

18. The method of claim 13, wherein the plane is tilted vertically and the two depth parameters are respectively representative of a depth value of a sample on a top border line of the coding block and on a bottom border line of the coding block.

19. The method of claim 18, wherein the two depth candidates for the coding block are a top-left adjacent block and a bottom-left adjacent block.

20. The method of claim 13, wherein the plane is tilted horizontally and the depth parameters are respectively representative of a depth value of a sample on a left border line of the coding block and on a right border line of the coding block.

21. The method of claim 20, wherein the two depth candidates for the coding block are a top-left adjacent block and a top-right adjacent block.

22-24. (canceled)

25. An apparatus comprising a memory and one or more processors, wherein the one or more processors are configured to:
obtain a coding block in a current image;
determine two depth candidates for the coding block, wherein a first depth candidate is obtained from a first adjacent block to the coding block and a second depth candidate is obtained from a second adjacent block to the coding block, wherein a depth model for the coding block includes a plane tilted vertically or horizontally with respect to a camera's sensor and is characterized by two depth parameters;
derive two depth parameters of a depth model for the coding block from the first depth candidate and from the second depth candidate;
determine a motion compensated prediction of the coding block with respect to a reference image from the depth model for the coding block, where motion information used in motion compensation is representative of camera motion between the current image and the reference image; and
encode the coding block based on the motion compensated prediction.

26. An apparatus comprising a memory and one or more processors, wherein the one or more processors are configured to:
obtain a coding block in a current image;
determine two depth candidates for the coding block, wherein a first depth candidate is obtained from a first adjacent block to the coding block and a second depth candidate is obtained from a second adjacent block to the coding block, wherein a depth model for the coding block includes a plane tilted vertically or horizontally with respect to a camera's sensor and is characterized by two depth parameters;
derive two depth parameters of a depth model for the coding block from the first depth candidate and from the second depth candidate;
determine a motion compensated prediction of the coding block with respect to a reference image from the depth model for the coding block, where motion information used in motion compensation is representative of camera motion between the current image and the reference image; and
decode the coding block based on the motion compensated prediction.

27-29. (canceled)

30. The apparatus of claim 25, wherein a depth candidate among the two depth candidates comprises a depth information associated to an adjacent block.

31. The apparatus of claim 26, wherein a depth candidate among the two depth candidates comprises a depth information associated to an adjacent block.
